(19) United States
(12) Patent Application Publication
(10) Pub. No.: US 2012/0171507 A1
(43) Pub. Date: Jul. 5, 2012

(54) ELECTROLYTIC MACHINING METHOD AND SEMIFINISHED WORKPIECE BY THE ELECTROLYTIC MACHINING METHOD

(75) Inventors: JUNG-CHOU HUNG, KAOHSIUNG CITY (TW); DA-YU LIN, TAICHUNG CITY (TW)

(73) Assignee: METAL INDUSTRIES RESEARCH & DEVELOPMENT CENTRE, KAOHSIUNG CITY (TW)

(21) Appl. No.: 13/242,661

(22) Filed: Sep. 23, 2011

(30) Foreign Application Priority Data
Dec. 30, 2010 (TW) 099146789

(51) Int. Cl. B32B 15/01; B32B 3/00; B23H 3/00

(52) U.S. Cl. 428/600; 205/666

(57) ABSTRACT

The present invention relates to an electrolytic machining method. For increasing size precision of electrolytic machining method, a metallic mask layer is formed on the surface of a workpiece whose material has high conductivity or volume electrochemical equivalent, whereby the metallic mask layer can be used as a sacrificial layer of electrolytic machining and simultaneously protects the non-machining region of the workpiece so as to reduce lateral machining of the workpiece Consequently, the size precision of electrolytic machining is enhanced. In addition, the feasibility of electrolytically machining a miniature interval between two machined structures is increased as well. In addition, the present invention provides a semifinished electrolytic workpiece, comprising a workpiece and a metallic mask layer formed on the surface of the workpiece. The conductivity or volume electrochemical equivalent of the metallic mask layer is smaller than that of the workpiece.

This application claims the priority benefit of Taiwan Patent Application Ser. No. 099146789 on Dec. 30, 2010, the full disclosure of which is incorporated herein by reference.

### FIELD OF THE INVENTION

The present invention relates generally to an electrolytic machining method, and particularly to an electrolytic machining method capable of enhancing size precision.

### BACKGROUND OF THE INVENTION

In recent years, in addition to improving varieties in functionality, 3C, biomedical, and emerging energy products also feature smaller size and lighter weight as well as emphasize precision and quality of products. The capable requirements in size and quality of machining product parts are greater accordingly. Besides, the characteristics of applied materials, such as hardness and elongation, also tend to varieties. It would be difficult to meet the requirements in quality, throughput, and cost if traditional mechanical machining technologies are merely adopted.

Currently, a precision electrochemical machining method has surmounted the limitations of a traditional electrochemical machining method in precision, and becomes a machining method with mass productivity, low cost, and high precision concurrently, thereby being researched and applied extensively worldwide in recent years. Since the material of workpiece at the anode is machined by means of ionization, it can acquire superior quality of machined surface with fine surface roughness. In addition, owing to the lack of cutting force or heat reaction, there will be no drawbacks such as residual stress after cutting, surface micro cracks, and thermal deteriorating layers. The precision electrochemical machining method also can perform rapid and whole-piece machining steps on a workpiece with a complicated shape, and its machining speed is not limited by the hardness, strength, and toughness of the material of the workpiece.

FIG. 1 shows a schematic diagram of electrolytic machining method according to the prior art. As shown in the figure, a workpiece 10′ being at the anode and an electrode unit 20′ being at the cathode are provided while electrolytic machining method is performed. The electrode unit 20′ has a conductive machining part 21′, wherein there exists a gap between the workpiece 10′ and the electrode unit 20′ for allowing electrolyte passing through therebetween. In addition, the workpiece 10′ and the electrode unit 20′ are connected electrically to a power supply 30′. While performing electrolytic machining, the region on the workpiece 10′ corresponding to the conductive machining part 21′ will be electrolytically machined for forming a machined structure 15′. After machining, the area of the machined structure 15′ on the workpiece 10′ will be greater than the projected area of the conductive machining part 21′ on the workpiece 10′.

As shown in FIG. 2, while machining two machined structures with a relatively smaller interval on the workpiece 10′, and thus the electrode unit 20′ will have two conductive machining parts 21′ with a relatively smaller interval therebetween. It is very possible that the corresponding machined regions on the workpiece 10′ overlap, such that an unidentifiable machined structure 15′ instead of two distinct machined structures 15′. Consequently, the predetermined machining precision and shape can not be achieved, especially for machining metals, such as magnesium, aluminum, copper or lithium, with high conductivity or high volume electrochemical equivalent.

### SUMMARY

An objective of the present invention is to provide an electrolytic machining method. A metallic mask layer is disposed on the surface of a workpiece as a sacrificial layer. By the property that the electrolytic machining rate of the metallic mask layer is slower than that of the workpiece, the metallic mask layer can be used as a protective mask layer, thereby retarding width direction (lateral) machining of the machined structure. Accordingly, the shape formed on the workpiece can coincide with the predetermined one, improving machining precision of the workpiece. In addition, the method solves the problem of machining micro structures on a workpiece as well as reducing the problem of overlaps in machining regions due to small intervals while electrolytic machining, especially for the workpiece with high conductivity and high volume electrochemical equivalent.

For achieving the objective described above, the present invention provides an electrolytic machining method, comprising steps of: providing a workpiece and forming a metallic mask layer on the surface of the workpiece; providing an electrode unit, corresponding to the metallic mask layer, and having at least one conductive machining part; providing an electrolyte between the workpiece and the electrode unit; providing a power supply to the workpiece and the electrode unit; electrolyzing the metallic mask layer, and forming at least one penetrating structure in the metallic mask layer, wherein the penetrating structure is corresponding to the conductive machining part of the electrode unit and exposes a region of the workpiece; electrolytically machining on the region of said workpiece through the penetrating structure, wherein the electrolytic machining rate of the workpiece is greater than that of the metallic mask layer so as to form at least one machined structure on the workpiece; and removing the metallic mask layer and acquiring the workpiece with at least one machined structure.

Besides, the present invention provides another electrolytic machining method, comprising steps of: providing a workpiece; covering the surface of the workpiece with a metallic mask layer having at least one penetrating structure for exposing partial surface of the workpiece; providing an electrode unit, wherein the electrode unit is corresponding to the metallic mask layer, and has at least one conductive machining part corresponding to the penetrating structure of the metallic mask layer; providing an electrolyte between the workpiece and the electrode unit; providing a power supply to the workpiece and the electrode unit; performing electrolytically machining on the exposed partially surface of the workpiece, wherein the electrolytic machining rate on the workpiece is greater than that on the metallic mask layer for forming at least one machined structure on the workpiece; and removing the metallic mask layer, and giving the workpiece with at least one machined structure.

The present invention provides a semifinished electrolytic workpiece by the electrolytic machining method, comprising a workpiece and a metallic mask layer formed on the surface of the workpiece. The conductivity of the metallic mask layer is smaller than that of the workpiece.

The present invention provides another semifinished electrolytic workpiece by the electrolytic machining method, comprising a workpiece and a metallic mask layer formed on the surface of the workpiece. The volumetric electrochemical equivalent of the metallic mask layer is smaller than that of the workpiece.

### BRIEF DESCRIPTION OF THE DRAWINGS

FIG. 1 shows a schematic diagram of electrolytic machining according to the prior art;

FIG. 2 shows another schematic diagram of electrolytic machining according to the prior art;

FIG. 3 shows a flowchart of electrolytic machining according to the first embodiment of the present invention;

FIGS. 4 to 7 show schematic diagrams of steps of electrolytic machining according to the first embodiment of the present invention;

FIG. 8 shows a schematic diagram of disposing a metallic mask layer on the surface of a workpiece according the second embodiment of the present invention; and

FIG. 9 shows a schematic diagram of a step of electrolytic machining according to the second embodiment of the present invention.

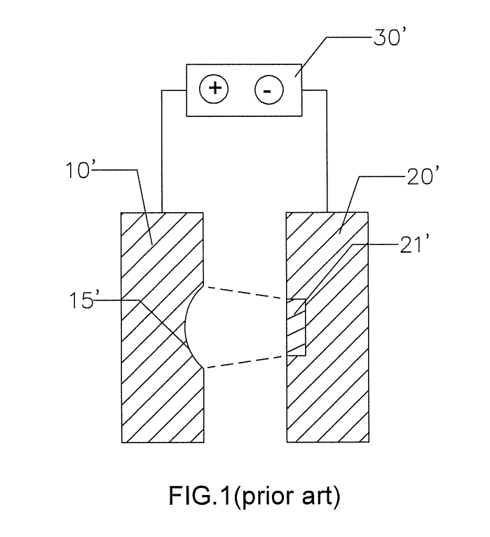

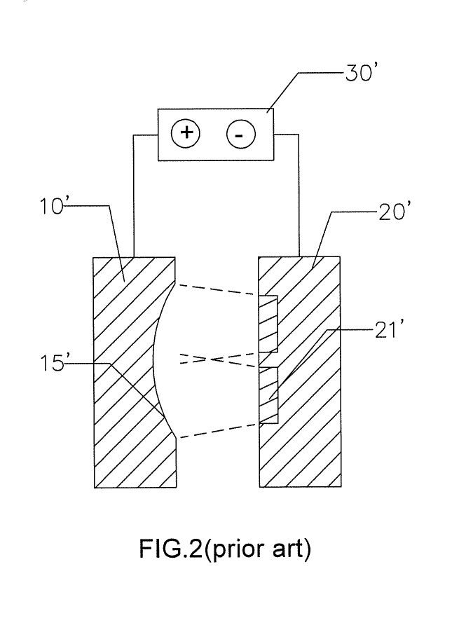

### DETAILED DESCRIPTION

In order to make the structure and characteristics as well as the effectiveness of the present invention to be further understood and recognized, the detailed description of the present invention is provided as follows along with embodiments and accompanying figures.

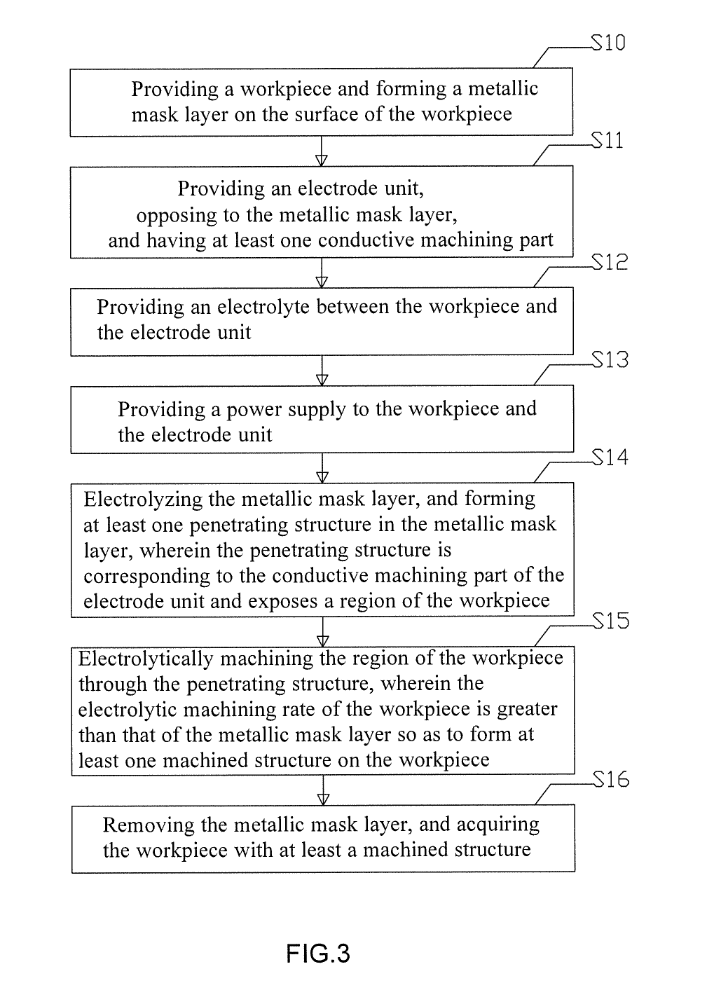

Please refer to FIGS. 3 to 7, they depict an electrolytic machining method according to the first embodiment of the present invention. For increasing size precision of electrolytic machining method, a metallic mask layer is formed on the surface of a workpiece whose material specially has high conductivity or volume electrochemical equivalent, whereby the metallic mask layer can be used as a sacrificial layer of electrolytic machining and simultaneously protects the non-machining region of the workpiece so as to reduce lateral machining of the workpiece. Consequently, the size precision of electrolytic machining is enhanced. In addition, the feasibility of electrolytically machining a miniature interval between two machined structures is increased as well.

FIG. 3 shows a flowchart of electrolytic machining method according to the first embodiment of the present invention. The electrolytic machining method comprises steps of:
S10: Providing a workpiece and forming a metallic mask layer on the surface of the workpiece;
S11: Providing an electrode unit, opposing to the metallic mask layer and having at least one conductive machining part;
S12: Providing an electrolyte between the workpiece and the electrode unit;
S13: Providing a power supply to the workpiece and the electrode unit;
S14: Electrolyzing the metallic mask layer, and forming at least one penetrating structure in the metallic mask layer, wherein the penetrating structure is corresponding to the conductive machining part of the electrode unit and exposes a region of the workpiece;
S15: Electrolytically machining the region of the workpiece through the penetrating structure, wherein the electrolytic machining rate of the workpiece is greater than that of the metallic mask layer so as to form at least one machined structure on the workpiece; and
S16: Removing the metallic mask layer, and acquiring the workpiece with at least one machined structure.

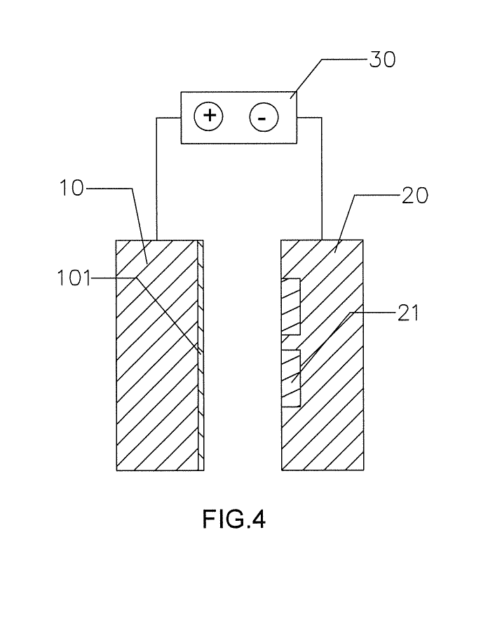

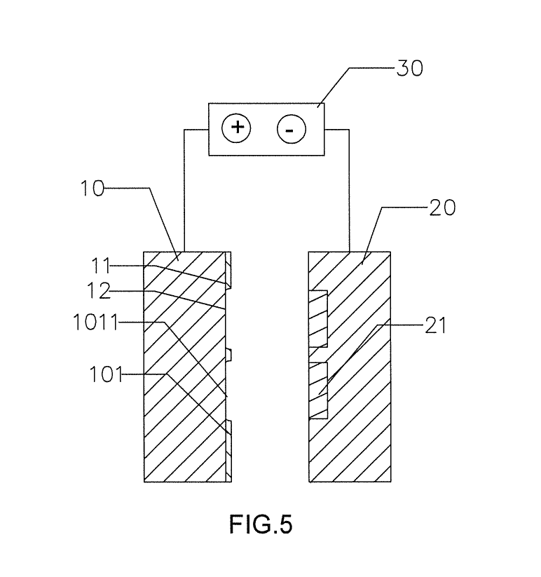

As shown in FIG. 4, the workpiece 10 is provided, and the metallic mask layer 101, which is used as a sacrificial layer, is formed on the surface of the workpiece 10. The metallic mask layer 101 can cover completely a non-machining region 11 and a machining region 12 (as shown in FIG. 5). The electrode unit 20 corresponds to the metallic mask layer 101 and has at least one conductive machining part 21.

Please refer to FIG. 5. After the metallic mask layer 101 is disposed on the machining surface of the workpiece 10, electrolytic machining is performed. When the power supply 30 supplies power to the workpiece 10 and the electrode unit 20 and the workpiece 10 is electrolytically machined, the metallic mask layer 101 corresponding to the conductive machining part 21 will be electrolytically machined first. Thus, the penetrating structure 1011 is formed on the metallic mask layer 101, and exposes the machining region of the workpiece 10 for electrolytic machining. While performing the electrolytic machining described above, an electrolyte (not shown in the figure) will be provided between the workpiece 10 and the electrode unit 20.

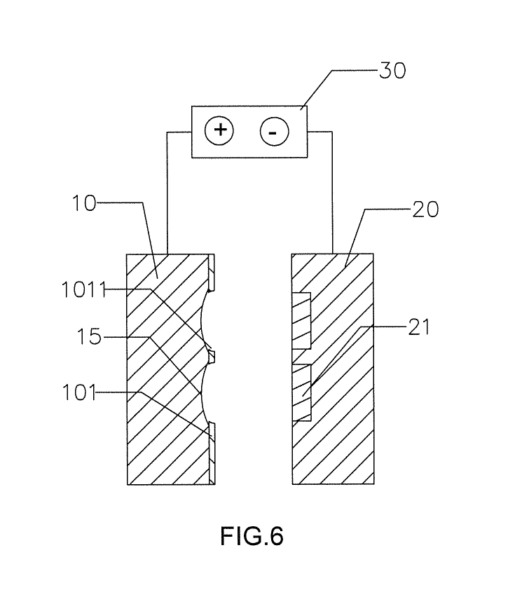

FIG. 6 shows a schematic diagram of electrolytic machining. For continuously electrolytically machining the workpiece 10, after the penetrating structure 1011 is formed in the metallic mask layer 101, the workpiece 10 is continuously electrolyzed through the penetrating structure 1011, thereby forming the machined structure 15 on the workpiece 10.

Nonetheless, the above figures are used for facilitating descriptions, not for limiting the spirit of the present invention. For example, in FIGS. 5 and 6, while forming the penetrating structure in the metallic mask layer 101 and exposing the machining region 12 of the workpiece 10, the machining region 12 of the workpiece 10 has already electrolyzed.

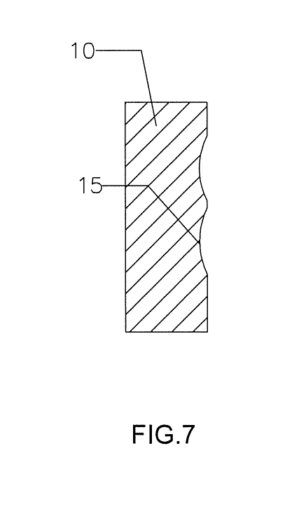

FIG. 7 shows a schematic diagram of electrolytic machining. The metallic mask layer 101 is further removed, and then the workpiece 10 has at least one machined structure 15. The method for removing the metallic mask layer 101 includes, for example, removing the metallic mask layer 101 from the workpiece 10 by nitric acid.

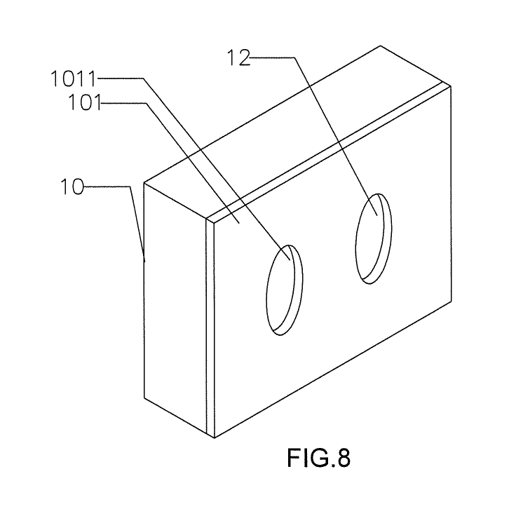

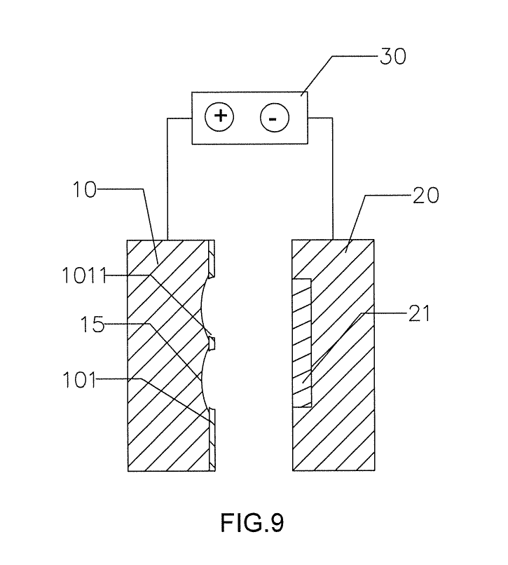

Please refer to FIG. 8, it depicts an electrolytic machining method according to a second embodiment of the present invention. The difference between the second embodiment and the first embodiment is that: the surface of the workpiece 10 is covered with a metallic mask layer 101 having a penetrating structure 1011, which exposes the surface of the workpiece 10 to be machined. The conductive machining part 21 of the electrode unit 20 is corresponding to the penetrating structure 1011 of the metallic mask layer 101. Thus, during the electrolytic machining process, the surface of the workpiece 10 is electrolytically machined directly so as to form at least one machined structured 15 on the workpiece 10. It does not require the step of forming the penetrating structure 1011 by electrolytic machining in the metallic mask layer 101. Accordingly, as shown in FIG. 9, a plurality of conductive machining parts 21 on the electrode unit 20 in the first embodiment can be replaced by a single conductive machining part 21 in the second embodiment, thereby simplifying the processing procedure of forming the conductive machining part 21. The electrolytic machining rate of the workpiece 10 is greater than that on the metallic mask layer 101. While electrolytically machining the workpiece 10, the metallic mask layer 101 corresponding to the conductive machining part 21 will be electrolytically machined as well. Nevertheless, the electrolytic machining rate of the metallic mask layer 101 is smaller than that on the workpiece 10. Thus, when the machined structure 15 is formed on the surface of the workpiece 10, the metallic mask layer 101 corresponding to the conductive machining part 21 is not electrolyzed completely. Consequently, the metallic mask layer 101 can still cover the non-machining region of the workpiece 10 without affecting the machining precision on the workpiece 10.

In the first and second embodiments, the material of the workpiece 10 is copper alloy and the material of the metallic mask layer is nickel alloy. Besides, the metallic mask layer 101 can be formed on the surface of the workpiece 10 by the electroless plating method, wherein the metallic mask layer 101 has a preferable thickness of 2 to 5 μm. According to the electrolytic machining method, both of the workpiece 10 and the metallic mask layer 101 can be processed in the same electrolyte, such as a nitrate solution. Electrolytic machining is performed by taking advantage of the electrolytic machining rate of the workpiece 10 being greater than that of the metallic mask layer 101. Since electrolytic machining rate is proportional to the volume electrochemical equivalent and conductivity of materials, the electrolytic machining method of the present invention is suitable for machining the workpiece 10 made of material having high conductivity, the material being magnesium, aluminum, copper or lithium. The materials of the metallic mask layer 101 can be metal materials with low conductivity, such as chromium, nickel, or manganese. Thus, the size precision of electrolytic machining can be improved. In other words, in the electrolytic machining method, the semifinished workpiece according to the present invention (as shown in FIG. 8) comprises the workpiece 10 and the metallic mask layer 101 formed on the surface of the workpiece 10. The conductivity or the volume electrochemical equivalent of the metallic mask layer 101 is smaller than that of the workpiece 10.

Accordingly, as shown in FIG. 5, while electrolytically machining the metallic mask layer 101 on the workpiece 10, the conductivity of the metallic mask layer 101 is smaller than that of the workpiece 10, and thus the width of the opening in the penetrating structure 1011 of the metallic mask layer 101 can be reduced. Therefore, the opening area in the penetrating structure 1011 approximates to the projected area of the conductive machining part 21 on the workpiece 10. While electrolytically machining the workpiece 10 subsequently, the metallic mask layer 101 can be used as a protective mask by taking advantage of the electrolytic machining rate on the metallic mask layer 101 being slower than that on the workpiece 10. Consequently, the machining rate of the machined structure 15 in the width (lateral) direction is slowed down, thereby increasing the depth-to-width aspect ratio of the machined structure 15.

To sum up, according to the electrolytic machining method of the present invention, a metallic mask layer is formed on the surface of the workpiece, and the electrolytic machining rate of the workpiece is greater than that on the metallic mask layer. By using the metallic mask layer, the non-machining region of the workpiece is not extended, thereby enhancing size precision of the workpiece during electrolytic machining.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An electrolytic machining method, comprising steps of:
providing a workpiece and forming a metallic mask layer on a surface of said workpiece;
providing an electrode unit, opposing to said metallic mask layer, and having at least one conductive machining part;
providing an electrolyte between said workpiece and said electrode unit;
providing a power supply to said workpiece and said electrode unit;
electrolyzing said metallic mask layer, and forming at least one penetrating structure in said metallic mask layer, wherein the penetrating structure is corresponding to said conductive machining part of said electrode unit and exposes a region of the workpiece;
electrolytically machining on the region of said workpiece through the penetrating structure, wherein the electrolytic machining rate of said workpiece is greater than that of said metallic mask layer so as to form at least one machined structure on said workpiece; and
removing said metallic mask layer and acquiring said workpiece with at least one machined structure.

2. The electrolytic machining method of claim 1, wherein said step of forming a metallic mask layer on the surface of said workpiece includes using an electroless plating method so as to form said metallic mask layer on said workpiece.

3. The electrolytic machining method of claim 1, wherein the thickness of said metallic mask layer is between 2 and 5 μm.

4. The electrolytic machining method of claim 1, wherein the material of said workpiece includes one of magnesium, aluminum, copper and lithium, and the material of said metallic mask layer includes one of chromium, nickel and manganese.

5. The electrolytic machining method of claim 1, wherein the conductivity of said metallic mask layer is smaller than the conductivity of said workpiece.

6. The electrolytic machining method of claim 1, wherein the volume electrochemical equivalent of said metallic mask layer is smaller than the volume electrochemical equivalent of said workpiece.

7. An electrolytic machining method, comprising steps of:
providing a workpiece;
covering a surface of said workpiece with a metallic mask layer having at least one penetrating structure for exposing partial surface of said workpiece;
providing an electrode unit, wherein the electrode unit is corresponding to said metallic mask layer and has at least one conductive machining part corresponding to said penetrating structure of said metallic mask layer;
providing an electrolyte between said workpiece and said electrode unit;
providing a power supply to said workpiece and said electrode unit;
electrolytically machining the exposed partially surface of said workpiece, wherein the electrolytic machining rate on said workpiece is greater than that on said metallic mask layer for forming at least one machined structure on said workpiece; and
removing said metallic mask layer, and acquiring said workpiece with at least one machined structure.

8. The electrolytic machining method of claim 7, wherein the material of said workpiece includes one of magnesium, aluminum, copper and lithium.

9. The electrolytic machining method of claim 7, wherein the material of said metallic mask layer includes one of chromium, nickel and manganese.

10. The electrolytic machining method of claim 7, wherein the thickness of said metallic mask layer is between 2 and 5 μm.

11. The electrolytic machining method of claim 7, wherein the conductivity of said metallic mask layer is smaller than the conductivity of said workpiece.

12. The electrolytic machining method of claim 7, wherein the volume electrochemical equivalent of said metallic mask layer is smaller than the volume electrochemical equivalent of said workpiece.

13. A semifinished workpiece, comprising:
a workpiece; and
a metallic mask layer formed on a surface of said workpiece;
wherein the conductivity of said metallic mask layer is smaller than the conductivity of said workpiece, or the volume electrochemical equivalent of said metallic mask layer is smaller than the volume electrochemical equivalent of said workpiece.

14. The semifinished workpiece of claim 13, wherein the material of said workpiece includes one of magnesium, aluminum, copper and lithium

15. The semifinished workpiece of claim 13, wherein the material of said metallic mask layer includes one of chromium, nickel and manganese.

16. The semifinished workpiece of claim 13, wherein the thickness of said metallic mask layer is between 2 and 5 μm.
